(19) United States
(12) Patent Application Publication
(10) Pub. No.: US 2005/0129066 A1
(43) Pub. Date: Jun. 16, 2005

(54) Systems, methods, and storage medium for transmitting data over a computer network

(76) Inventor: Steven Tischer, Atlanta, GA (US)

Correspondence Address: Philmore H. Colburn II;Cantor Colburn LLP, 55 Griffin Road South, Bloomfield, CT, 06002, US

(21) Appl. No.: 10/735,931

(22) Filed: Dec. 15, 2003

(51) Int. Cl. H04L 12/56

(52) U.S. Cl. 370/476; 370/355

(57) ABSTRACT

A system, method, and storage medium for transmitting data over a computer network to a predetermined recipient is provided. The system includes a first device configured to modify at least one data byte in a first data message based on a first message modification key value to obtain a modified first data message. The first message modification key value is determined based on at least one variable parameter. The first device is further configured to modify at least one data byte in a second data message based on a second modification key value to obtain a modified second data message. The second message modification key value is determined based on at least one variable parameter. The first device is further configured to transmit the first and second modified data messages. The system further includes a second device configured to receive the transmitted first and second modified data messages and to determine the first data message for the predetermined recipient based on the modified first data message and the first message modification key value. Finally, the second device is configured to determine the second data message for the predetermined recipient based on the modified second data message and the second message modification key value.

### FIELD OF INVENTION

The present invention relates to systems, methods, and a storage medium for transmitting data over a computer network.

### BACKGROUND

Systems have been developed which allow a user to query information from a remote computer. The systems have utilized a “smart card” which periodically generates a smart card number that can be utilized by a user when logging into the remote computer. These systems, however, have not modified the content of a plurality of data messages transmitted from a computer to a predetermined recipient wherein the content of each data message is modified differently based on upon a varying modification key value for a more secure data transmission.

### SUMMARY OF THE INVENTION

The foregoing problems and disadvantages are overcome by a system, a method, and a storage media for transmitting data over a computer network to a predetermined recipient.

A method for transmitting data over a computer network to a predetermined recipient is provided. The method includes modifying at least one data byte in a first data message based on a first message modification key value to obtain a modified first data message. The first message modification key value is determined based on at least one variable parameter. The method further includes modifying at least one data byte in a second data message based on a second modification key value to obtain a modified second data message. The second message modification key value is determined based on at least one variable parameter. The method further includes transmitting the first and second modified data messages to a first device. The method further includes determining the first data message in the first device for the predetermined recipient based on the modified first data message and the first message modification key value. Finally, the method includes determining the second data message in the first device for the predetermined recipient based on the modified second data message and the second message modification key value.

A system for transmitting data over a computer network to a predetermined recipient. The system includes a first device configured to modify at least one data byte in a first data message based on a first message modification key value to obtain a modified first data message. The first message modification key value is determined based on at least one variable parameter. The first device is further configured to modify at least one data byte in a second data message based on a second modification key value to obtain a modified second data message. The second message modification key value is determined based on at least one variable parameter. The first device is further configured to transmit the first and second modified data messages. The system further includes a second device configured to receive the transmitted first and second modified data messages and to determine the first data message for the predetermined recipient based on the modified first data message and the first message modification key value. Finally, the second device is configured to determine the second data message for the predetermined recipient based on the modified second data message and the second message modification key value.

A storage medium encoded with machine-readable computer program code for transmitting data over a computer network is provided. The storage medium includes instructions for causing at least one network element to implement a method comprising modifying at least one data byte in a first data message based on a first message modification key value to obtain a modified first data message. The first message modification key value is determined based on at least one variable parameter. The method further includes modifying at least one data byte in a second data message based on a second modification key value to obtain a modified second data message, the second message modification key value being determined based on at least one variable parameter. The method further includes transmitting the first and second modified data messages to a first device. The method further includes determining the first data message in the first device for the predetermined recipient based on the modified first data message and the first message modification key value. The method further includes determining the second data message in the first device for the predetermined recipient based on the modified second data message and the second message modification key value.

Other systems, methods, and computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic of a system for transmitting data over a computer network.

FIG. 2 is a schematic of a first voice signal generated by a telephone.

FIG. 3 is a schematic of a plurality of binary values representing the first voice signal of FIG. 2.

FIG. 4 is a schematic of a second voice signal generated by a telephone.

FIG. 5 is a schematic of a plurality of binary values representing the second voice signal of FIG. 4.

FIG. 6 is a schematic of an asynchronous transfer mode (ATM) cell structure for a data message.

FIG. 7 is a schematic of an ATM cell structure for a key message.

FIG. 8 is a schematic of an ATM cell structure for a combined data message and key message.

FIG. 9 is a schematic of calculation steps used to determine a first modification key value (K1).

FIG. 10 is a schematic of calculation steps used to determine a second modification key value (K2).

FIGS. 11A-11D are flowcharts of the method for transmitting data over a computer network to predetermined recipient.

### DETAILED DESCRIPTION OF THE INVENTION

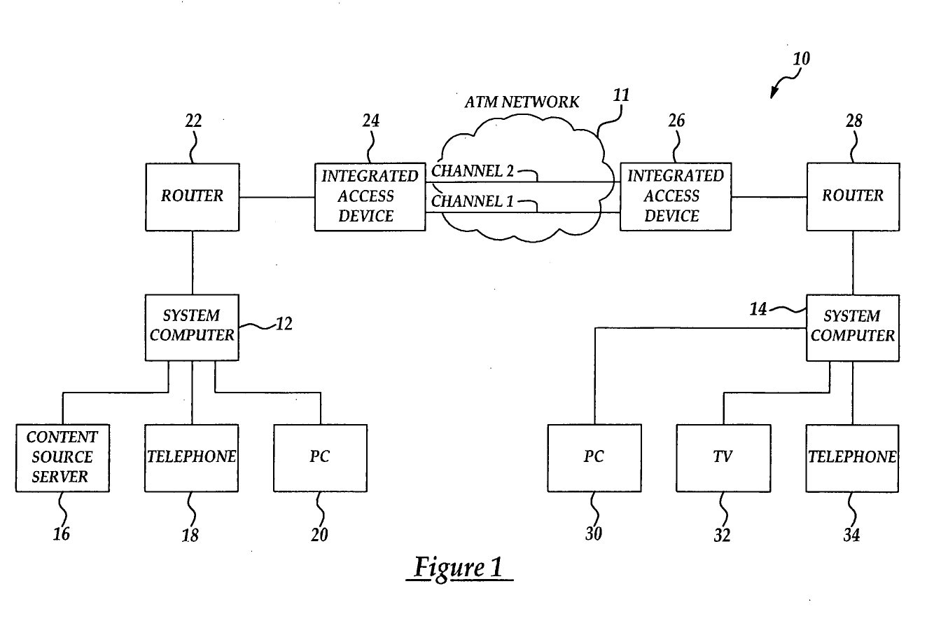

Referring to the drawings, identical reference numerals represent identical components in the various views. Referring to FIG. 1, a system 10 for transmitting data over an asynchronous transfer mode (ATM) network 11 is provided. The system 10 may further include system computers 12, 14, content source server 16, a telephone 18, a personal computer (PC) 20, a router 22, integrated access devices 24, 26, a router 28, a PC 30, a television 32, and a telephone 34.

ATM network 11 is provided to transmit voice, video, and data traffic between integrated access devices 24, 26. ATM network 11 includes two communication channels, (e.g., Channel 1 and Channel 2), between devices 24, 26. ATM network 11 transfers data in ATM cells having a fixed length of 53 bytes. Each. ATM cell includes a cell header containing five bytes of information needed to route the information through ATM network 11. The remaining 48 bytes of each cell can contain data to be transferred. It should be noted that any known communication network capable of transmitting voice data or video data could be used instead of ATM network 11. For example, ATM network 11 could be replaced with an internet protocol (IP) network, an ethernet network, or an ultra-wide band network.

Computer 12 is provided to receive analog or digital data signals from content source server 16, telephone 18, or PC 20 and to modify the data signals prior to being transmitted through ATM network 11. Content source server 16 may comprise a computer server storing various types of content including (i) video content, such as movies and TV show for example, and (ii) audio content, such as recorded music for example. As shown, computer 12 operably communicates with content source server 16, telephone 18, and PC 20. Computer 12 further operably communicates with router 22.

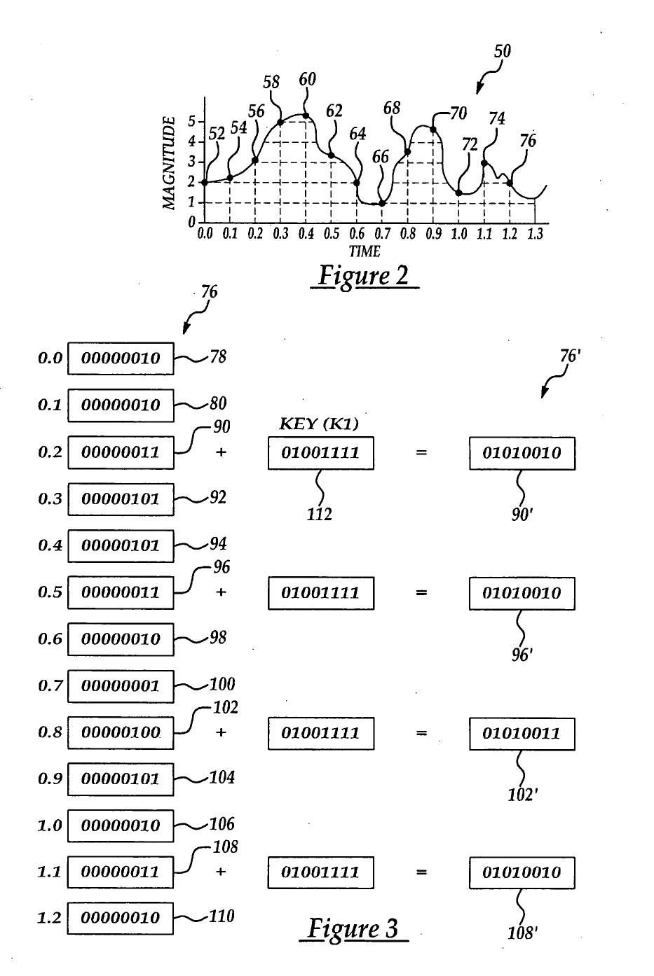

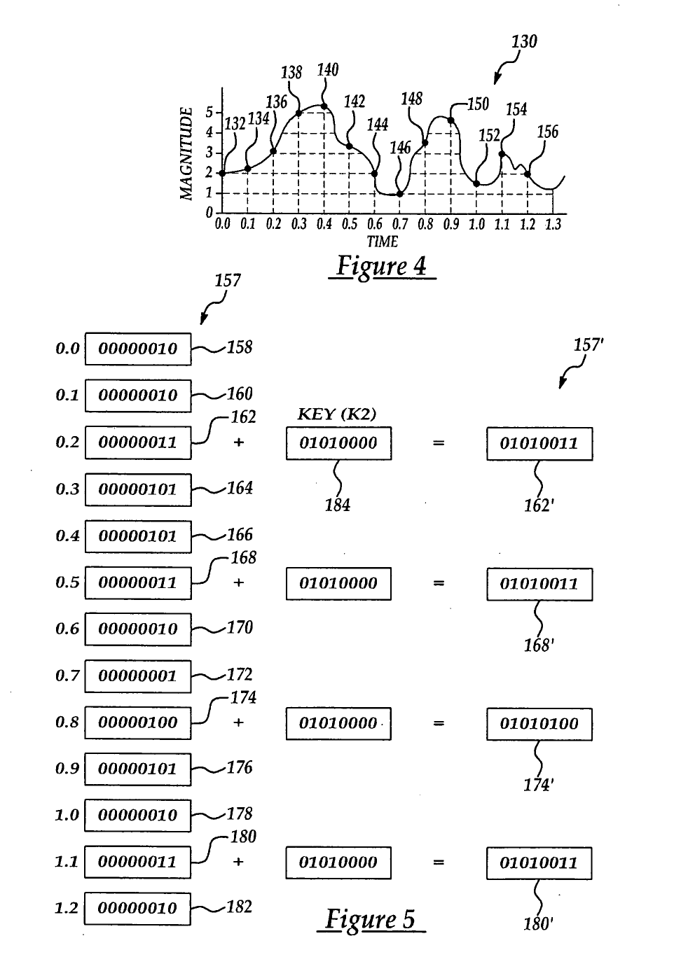

Referring to FIG. 2, an exemplary function of computer 12 will now be explained. As illustrated, a first voice signal 50 may be generated by telephone 18. Computer 12 may receive voice signal 50 and digitize signal 50 into a plurality of binary values. As shown computer 12 may receive voice signal 50 and sample voltage values 52, 54, 56, 58, 60, 62, 64, 66, 68, 70, 72, 74, 76 from signal 50 to obtain a plurality of data bytes 76 comprising binary values 78, 80, 90, 92, 94, 96, 98, 100, 102, 104, 106, 108, 110, respectively corresponding to the voltage values. For example, voltage sample 56 represents a voltage value of three volts which would have a binary value of “00000011”. Further, computer 12 may modify every third sampled value of signal 50 with a modification key value (K1) to obtain a modified plurality of data bytes 76′. For example, computer 14 may add the modification key value (K1) to data bytes 90, 96, 102, 108 to obtain the values 90′, 96′, 102′, 108′. Thereafter, computer 14 may substitute values 90′, 96′, 102′, 108′ for data bytes 90, 96, 102, 108 in the plurality of data bytes 76 to obtain a plurality of data bytes 76′.

Referring to FIG. 9, modification key value (K1) may be calculated by adding the numerical values of the month, day, year, hour, and minute to a sampled voice value of a recipient. For example, the modification key value (K1) determined on Dec. 18, 2003 at 4:29 P.M. could be calculated using the following equation:
time-varying variable(12+18+03+16+29=78=“01001110”)+voice sample of an intended recipient(“00000001”)=“01001111”.
The voice sample of the recipient may be generated by system computer 14 by having a recipient associated with telephone 34 (and PC 30, TV 32) speak a predetermined word/password that would be digitized and stored in a memory (not shown) in system computer 14. System computer 14 could transmit the stored voice sample through ATM network 11 to system computer 12 may could store the voice sample in a memory (not shown) in system computer 12). As will explained in greater detail below, the voice sample may be used to modify data messages transmitted between system computers 12, 14 over computer network 11 to ensure that only a device, such as a TV, telephone, or PC associated with an intended recipient can effectively utilize the data. It should be noted that in an alternate embodiment, other unique identifiers identifying the intended recipient of data could be utilized instead of the voice sample. For example, any other biometric identifier associated with the recipient could be used, such as a portion of a digitized photo of the recipient or a portion of a digitized retinal scan of the recipient. Further, the time varying parameter could be determined from other parameters other than the date and time. For example, the time varying parameter could be determined from a pseudo-randomly generated “smart card” ID that changes at predetermined time intervals. Thus, by modifying the portions of data transmitted through a computer network using both a time varying parameter and a unique identifier associated with an intended recipient, a more secure data transmission can be obtained over a computer network as compared to other systems.

A second voice signal 130 may be generated by telephone 18 after the first voice signal 50 is generated. Computer 12 may receive voice signal 130 and digitize signal 130 into a plurality of binary values. As shown computer 12 may receive voice signal 130 and sample voltage values 132, 134, 136, 138, 140, 142, 144, 146, 148, 150, 152, 154, and 156 from signal 130 to obtain a plurality of data bytes when 57 comprising binary values 158, 160, 162, 164, 166, 168, 170, 172, 174, 176, 178, 180, 182, respectively corresponding to the voltage values. For example, voltage sample 158 represents a voltage value of three volts which would have a binary value of “00000011”. Further, computer 12 may modify every third sampled value of signal 130 with a modification key value (K2) to obtain a modified plurality of data bytes 157′. For example, computer 14 may add the modification key value (K2) to data bytes 162, 168, 174, 180 to obtain the values 162′, 168′, 174′, 180′. Thereafter, computer 14 may substitute values 162′, 168′, 174′, 180′ for data bytes 162, 168, 174, 180 in the plurality of data bytes 157 to obtain a plurality of data bytes 157′.

Referring to FIG. 10, modification key value (K2) may be calculated by adding the numerical values of the month, day, year, hour, and minute to a sampled voice value of a recipient. For example, the modification key value (K2) determined on Dec. 18, 2003 at 4:29 P.M. could be calculated using the following equation:
time-varying variable(12+18+03+16+29=78=“01001111”)+voice sample of intended recipient(“00000001”)=“01010000”.

Router 22 is provided to receive a plurality of data bytes from computer 12 and generate ATM cells responsive thereto. For example, router 22 may receive a plurality of data bytes 76′ from computer 12 and may group the plurality of data bytes 76′ in one or more ATM cells for transmission through ATM network 11. The structure of the ATM cells will now be explained.

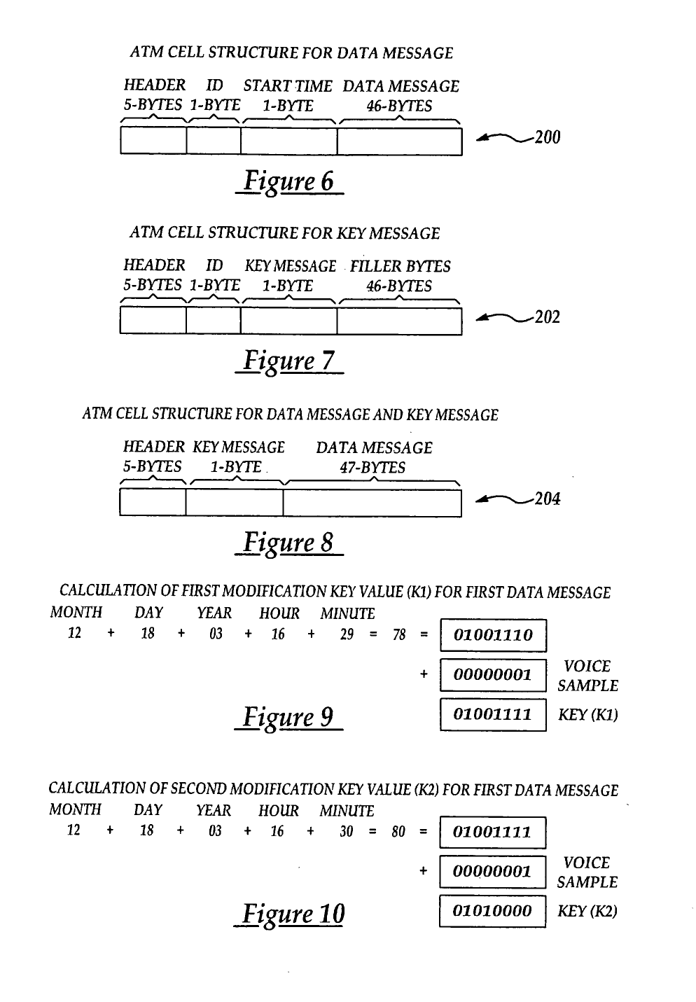

Referring to FIG. 6, router 22 may generate an ATM cell 200 for transmitting a data message. As shown, ATM cell 200 includes the following elements: (i) a Header, (ii) an ID, (iii) a Start Time, and (iv) a Data Message. The Header contains information needed to route the ATM cell 200 through ATM network 11 to a predetermined receiving device, such as PC 30, television 32, or telephone 34 for example. The Header may be 5-bytes in length. The ID corresponds to an identifier identifying the transmission device, such as content source server 16, telephone 18, or PC 20. The ID may be 1-byte in length. The ID will be utilized by system computer 14 to match an ATM cell 200 containing a data message with an ATM cell 202 containing a corresponding key message for decoding the Data Message in ATM cell 200 for example. A Start Time corresponds to a time when a voice signal (e.g., voice signal 50) begins to be generated. The Data Message corresponds to: (i) the plurality of data bytes (e.g., data bytes 76), and (ii) additional filler bytes (not shown) if needed to obtain a 46-byte Data Message.

Referring to FIG. 7, router 22 may also generate an ATM cell 202 containing a key message (e.g., a message containing a modification key value K1 or K2, for example) associated with ATM cell 200 for decoding the Data Message of ATM cell 200. As shown, ATM cell 202 includes the following elements: (i) a Header, (ii) an ID, (iii) a modification key value (K1), (iv) and filler bytes. Modification key value (K1) is provided to modify at least one data byte of the plurality of data bytes 76 generated from a first voice signal 50 to obtain the modified plurality of data byes 76′. Similarly, modification key value (K2) is provided to modify at least one data byte of the plurality of data bytes 157 generated from a second voice signal 130 to obtain the modified plurality of data byes 157′ shown in FIG. 10.

Referring to FIG. 8, it should be noted that router 22 may generate an ATM cell 204, instead of ATM cell's 200, 202, containing both a key message and a data message.

Referring to FIG. 1, integrated access devices 24, 26 are provided to transmit ATM through ATM network 11 using predetermined channels. For example, integrated access device 24 may ATM cells 200, 202 over Channels 1, 2, respectively, to integrated access device 26.

Router 28 is provided to receive ATM cells from integrated access device 26 and to route a modified plurality of data bytes in each ATM cell to system computer 14. For example, router 28 may receive ATM cell 200 and route the modified plurality of data bytes 76′ contained therein to computer 14. As described above, the plurality of data bytes 76 ′ corresponds to the plurality of data bytes 76 generated from voice signal 50 with every third data byte modified using a modification key value (K1). As shown router 28 operably communicates with device 26 and system computer 14.

Computer 14 is provided to receive a plurality of data bytes from router 28 and to transmit the data bytes to one or more receiving devices, such as PC 30, television 32, or telephone 34 for example. As shown, computer 14 operably communicates with router 28 and PC 30, television 32, and telephone 34. In particular, computer 14 may receive a plurality of modified data bytes 76′ corresponding to data bytes 78, 80, 90′, 92, 94, 96′, 98, 100, 102′, 104, 106, 108′, 110 and a modification key value (K1) from router 28. Computer 14 may subtract the value (K1) from the modified data bytes 90′, 96′, 102′, 108′ to obtain the values 90, 96, 102, 108. Thereafter, computer 14 may substitute values 90, 96, 102, 108 with data bytes 90′, 96′, 102′, 108′ to obtain plurality of data bytes 76 corresponding to voice signal 50. Thereafter, computer 14 may generate the voice signal 50 based upon the plurality of data bytes 76 and transmit voice signal 50 to telephone 34 for example. Alternately, if the ATM cells include a data message comprising video data (such as MPEG data), the system computer 14 could transmit the video data to either television 32 or personal computer 30 for example.

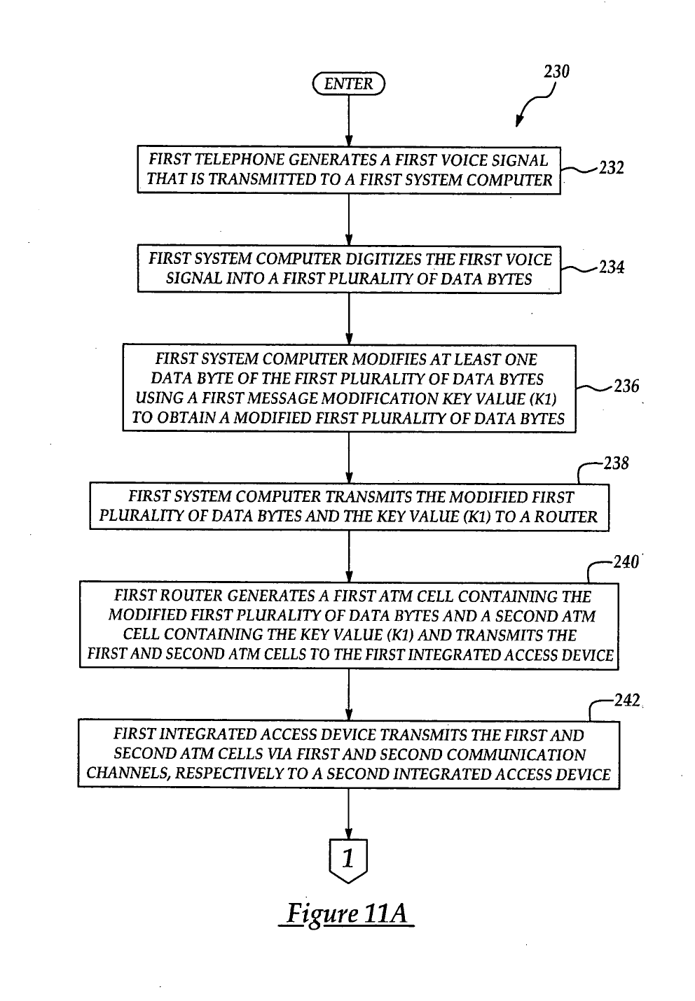

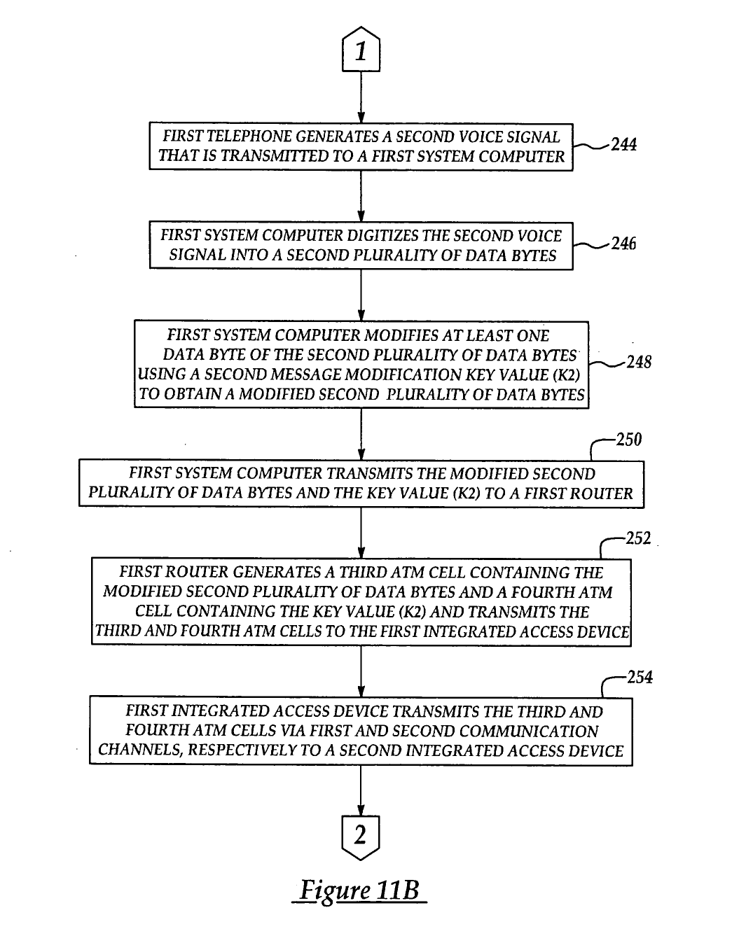

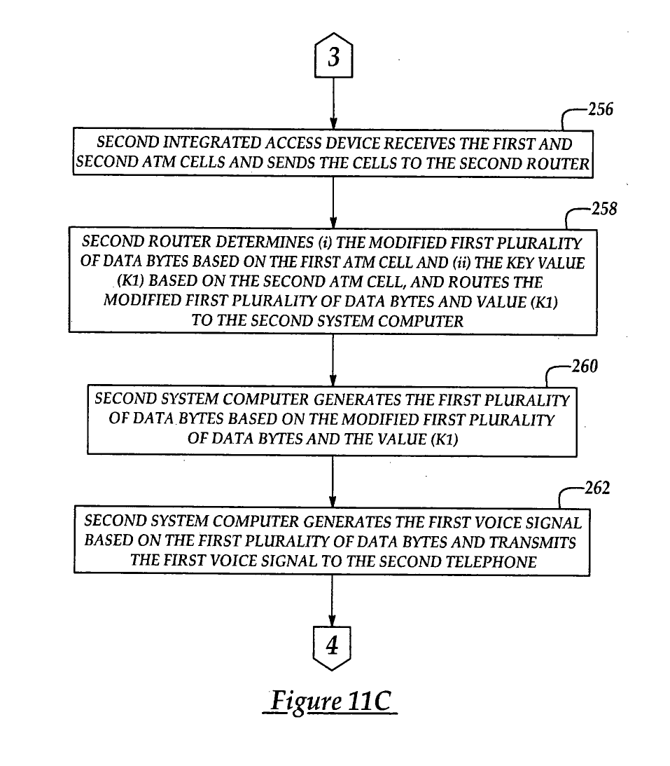

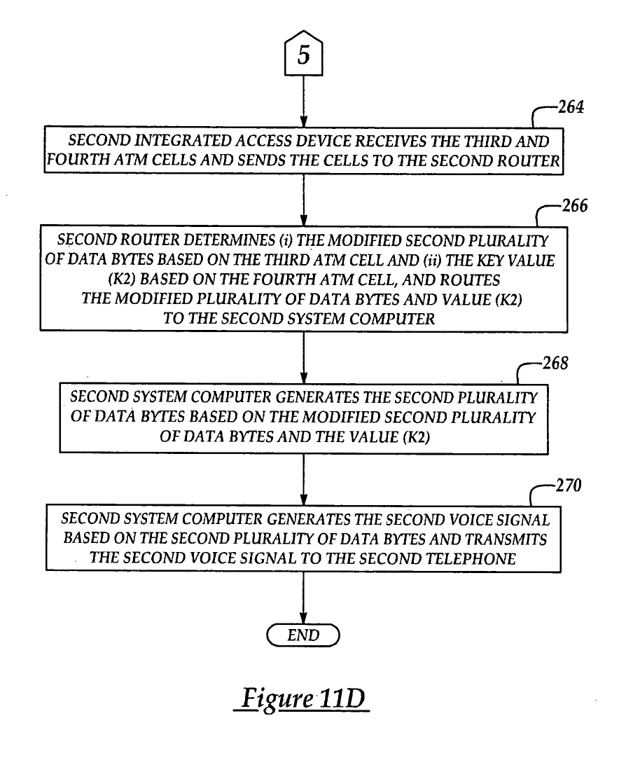

Referring to FIGS. 11A-11D, a method for transmitting data over a computer network will now be described. It should be noted that although the foregoing method will be described with respect to transmitting voice data, the method could be equally utilized for transmitting any type of data including video data for example. At step 232, telephone 18 generates a first voice signal 50 in response to an operator speaking into a microphone (not shown) within telephone 18 that is transmitted to system computer 12.

At step 234, system computer 12 digitizes the voice signal 50 into a plurality of data bytes 76.

At step 236, system computer 12 modifies at least one data byte of the first plurality of data bytes 76 using a message modification key value (K1) to obtain a modified plurality of data bytes 76′.

At step 238, system computer 12 transmits the modified plurality of data bytes 76′ and the key value (K1) to router 22.

At step 240, router 22 generates an ATM cell 200 containing the modified plurality of data bytes 76′ and an ATM cell 202 containing the key value (K1) and transmits ATM cells 200, 202 to integrated access device 24.

At step 242, integrated access device 24 transmits ATM cells 200, 202 via Channels 1 and 2, respectively, through ATM network 11 to integrated access device 26.

At step 244, telephone 18 generates a second voice signal 130 in response to an operator speaking into a microphone (not shown) within telephone 18 that is transmitted to system computer 12. It should be noted that the second voice signal 130 is generated after the first voice signal 50.

At step 246, system computer 12 digitizes voice signal 130 into a plurality of data bytes 157.

At step 248, system computer 12 modifies at least one data byte of the second plurality of data bytes 157 using a message modification key value (K2) to obtain a modified plurality of data bytes 157′.

At step 250, system computer 12 transmits the modified plurality of data bytes 157′ and the modification key value (K2) to router 22.

At step 252, router 22 generates an ATM cell 200′ containing the modified plurality of data bytes 157′ and an ATM cell 202′ containing the modification key value (K2) and transmits ATM cells 200′, 202′ to integrated access device 24.

At step 254, integrated access device 24 transmits ATM cells 200′, 202′ via Channels 1 and 2, respectively, through ATM network 11 to integrated access device 26.

At step 256, integrated access device 26 receives ATM cells 200, 202 and sends the cells 200, 202 to router 28.

At step 258, router 28 determines the modified plurality of data bytes 76′ and the modification key value (K1) based on the ATM cells 200, 202, respectively and routes data bytes 76′ and the modification key value (K1) to system computer 14.

At step 260, system computer 14 generates the plurality of data bytes 76 based on the modified plurality of data bytes 76′ and modification key value (K1).

At step 262, system computer 14 generates the voice signal 50 based on the plurality of data bytes 76 and transmits voice signal 50 to telephone 34.

At step 264, integrated access device 26 receives ATM cells 200′, 202′ and sends cells 200′, 202′ to router 28.

At step 266, router 28 determines the modified plurality of data bytes 157′ and the modification key value (K2) based on the ATM cells 200′, 202′, respectively and routes data bytes 157 ′ and modification key value (K2) to system computer 14.

At step 268, system computer 14 generates the plurality of data bytes 157 based on the modified plurality of data bytes 157′ and modification key value (K2).

At step 270, system computer 14 generates the voice signal 130 based on the plurality of data bytes 157 and transmits the voice signal 130 to telephone 34.

The present system, method, and storage medium for transmitting data over computer network provides a substantial advantage over other systems and methods.

In particular, the system, method, and storage medium modifies at least one data byte contained in each data message transmitted from a sending computer to a predetermined recipient computer based upon a varying modification key value for a more secure data transmission as compared other systems.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for transmitting data over a computer network to a predetermined recipient, the method comprising:
modifying at least one data byte in a first data message based on a first message modification key value to obtain a modified first data message, the first message modification key value being determined based on at least one variable parameter;
modifying at least one data byte in a second data message based on a second modification key value to obtain a modified second data message, the second message modification key value being determined based on at least one variable parameter;
transmitting the first and second modified data messages to a first device;
determining the first data message in the first device for the predetermined recipient based on the modified first data message and the first message modification key value; and,
determining the second data message in the first device for the predetermined recipient based on the modified second data message and the second message modification key value.

2. The method of claim 1 wherein the variable parameter comprises a time-varying parameter.

3. The method of claim 2 wherein the time-varying parameter includes at least one of a determined hour, minute, and second.

4. The method of claim 1 wherein the first message modification key value being determined based on at the least one variable parameter and a unique identifier associated with the predetermined recipient.

5. The method of claim 1 wherein the modifying at least one byte of the first data message includes adding the first message modification key value to the at least one data byte of the first data message.

6. The method of claim 1 further comprising transmitting the first and second message modification key values to a first computer.

7. The method of claim 1 wherein the first and second modified data messages are both transmitted via a first communication channel.

8. The method of claim 6 wherein the first and second message modification key values are both transmitted via a second communication channel.

9. The method of claim 1 wherein said first data message comprises voice data.

10. The method of claim 1 wherein said first data message comprises video data.

11. A system for transmitting data over a computer network to a predetermined recipient, the system comprising:
a first device configured to modify at least one data byte in a first data message based on a first message modification key value to obtain a modified first data message, the first message modification key value being determined based on at least one variable parameter, the first device further configured to modify at least one data byte in a second data message based on a second modification key value to obtain a modified second data message, the second message modification key value being determined based on at least one variable parameter, the first device configured to transmit the first and second modified data messages; and,
a second device configured to receive the transmitted first and second modified data messages and to determine the first data message for the predetermined recipient based on the modified first data message and the first message modification key value, the second device further configured to determine the second data message for the predetermined recipient based on the modified second data message and the second message modification key value.

12. The system of claim 11 wherein the first and second devices comprise first and second computers, respectively, operatively communicating with one another.

13. The system of claim 11 wherein the variable parameter comprises a time-varying parameter.

14. The system of claim 13 wherein the time-varying parameter includes at least one of a determined hour, minute, and second.

15. The system of claim 11 wherein the first message modification key value is determined based on at the least one variable parameter and a unique identifier associated with the predetermined recipient.

16. The system of claim 11 wherein the first device is configured to modify the at least one byte of a first data message by adding the first message modification key value to the at least one data byte of the first data message.

17. The system of claim 11 wherein the first device is further configured to transmit the first and second message modification key values to the second device.

18. The system of claim 11 wherein the first and second modified data messages are transmitted via a first communication channel.

19. The system of claim 11 wherein said first data message comprises voice data.

20. The system of claim 11 wherein said first data message comprises video data.

21. A storage medium encoded with machine-readable computer program code for transmitting data over a computer network, the storage medium including instructions for causing at least one network element to implement a method comprising:
modifying at least one data byte in a first data message based on a first message modification key value to obtain a modified first data message, the first message modification key value being determined based on at least one variable parameter;
modifying at least one data byte in a second data message based on a second modification key value to obtain a modified second data message, the second message modification key value being determined based on at least one variable parameter;
transmitting the first and second modified data messages to a first device;
determining the first data message in the first device for the predetermined recipient based on the modified first data message and the first message modification key value; and,
determining the second data message in the first device for the predetermined recipient based on the modified second data message and the second message modification key value.
